(19) United States
(12) Patent Application Publication
(10) Pub. No.: US 2025/0384014 A1
(43) Pub. Date: Dec. 18, 2025

(54) SYSTEM AND METHOD FOR ENHANCING NETWORK SERVER PERFORMANCE THROUGH SYNCHRONIZATION BASED CACHE

(71) Applicant: Resilio, Inc., San Francisco, CA (US)

(72) Inventor: Konstantin Lisunov, Las Vegas, NV (US)

(21) Appl. No.: 19/241,071

(22) Filed: Jun. 17, 2025

Related U.S. Application Data
(60) Provisional application No. 63/660,670, filed on Jun. 17, 2024.

(51) Int. Cl. G06F 16/178; G06F 16/172; G06F 16/188

(52) U.S. Cl. CPC G06F 16/178; G06F 16/172; G06F 16/188

(57) ABSTRACT

This disclosure presents a system and method aimed at optimizing network server performance via synchronization of local cached files, elevating user experience without necessitating server, security or networking configuration alterations. The innovation employs diverse techniques to enhance the performance of network shares, whether on-premise or cloud-based, leading to expedited response times and heightened efficiency for end-users. Additionally, the system facilitates offline access to files.

### BACKGROUND

Traditional network server setups often face performance hurdles, resulting in unsatisfactory user experiences. While it is possible to parallel reading requests and achieve good reading performance, write requests are impossible to parallel. The solution always requires constant online access to network shares, since most of the caches in OS require invalidation after a short period of time. File operational performance heavily relies on the network, with any network connection issues affecting file operation performance. Current remedies typically involve expensive hardware upgrades or intricate server adjustments. There exists a demand for a more streamlined approach to bolster network shares performance without substantial infrastructure modifications.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a high-level architectural overview of a distributed file system or a client-side caching and synchronization mechanism for cloud storage;

FIG. 2 illustrates a system for providing a filesystem on a local computer that includes a metainformation database, a virtual file system, a local cache, and a synchronization module that performs any of the steps discussed herein;

FIG. 3 shows a UE in accordance with some embodiments of the present disclosure; and

FIG. 4 is a block diagram illustrating a virtualization environment in which functions implemented by some embodiments may be virtualized in accordance with some embodiments of the present disclosure.

### SUMMARY

Systems and methods for enhancing network server performance through synchronization based cache are provided. In some embodiments, a system for proving a filesystem on a local computer includes: a metainformation database; a virtual file system capable of presenting the metainformation database as a standard file system; a local cache to provide file content for reading and writing; and a synchronization module providing bidirectional synchronization between metadata in the metainformation database and file content between one or more network shares and the local computer. In some embodiments, this system is real-time and collaborative. In some ways, this can decouple the User Experience (UX) from the actual file storage.

In some embodiments, the metainformation database is populated during an initial scan of one or more network shares. In some embodiments, the metainformation database stores diverse file and folder metadata. In some embodiments, updates to the metainformation database are bidirectionally synchronized with the network share.

In some embodiments, the virtual file system is capable of presenting the metainformation database as a standard file system without necessitating access to the one or more network shares.

In some embodiments, the virtual file system is capable of presenting the metainformation database as a standard file system through the local cache.

In some embodiments, the local cache uses local, high-speed, and reliable storage to provide file content for reading and writing.

In some embodiments, the synchronization module provides bidirectional synchronization using differential syncing. In some embodiments, the synchronization module provides algorithms for one or more of: error detection, recovery, and optimizing data transfer based on capabilities of the one or more network shares.

In some embodiments, the system also includes a predictive engine that analyzes file access patterns to proactively preload file content into the local cache from the one or more network shares. In some embodiments, the system also includes a file policy engine that governs management of the local cache. In some embodiments, the file policy engine provides one of more of: defining cache size, handling older files, caching criteria, and retention policies.

In some embodiments, the system also includes a file locking module. In some embodiments, the file locking module extends file locking to the one or more network shares. In some embodiments, the file locking module prevents concurrent write access when a file is opened locally.

In some embodiments, the system also includes a peer-to-peer data synchronization module that facilitates one or more of: metadata and file content exchange among users with access to the same folder without network share access. In some embodiments, when a user saves a file, the file is stored in the local cache, enabling parallel write requests to the one or more network shares.

In some embodiments, network server performance can be improved by one or more of: pre-populating file meta-information into the metainformation database to fulfill all meta-information requests from local storage; segregating file read/write operations from network share data transfer, ensuring users experience local disk IO performance, while file movement operations occur in the background without perceptible performance degradation; employing a robust synchronization engine to optimize write and read access to files, leveraging techniques such as block read/write, recovery of partially uploaded/downloaded files, and peer-to-peer optimization;
predicting user demand and pre-caching frequently accessed data using a predictive analysis module; dynamically distributing incoming requests across server nodes using a load balancing module; implementing error recovery mechanisms without requiring file retransfer; optimizing access to local files and folders' metadata; and employing various techniques for expedited storage access, including multi-threaded access and partial file access.

In some embodiments, a method for providing a filesystem on a local computer includes: populating a metainformation database during an initial scan of one or more network shares; presenting a virtual file system as a standard file system without necessitating access to the one or more network shares; using a local cache to provide file content for reading and writing; and providing bidirectional synchronization between metadata in the metainformation database and file content between one or more network shares and the local computer using a synchronization module.

### DETAILED DESCRIPTION

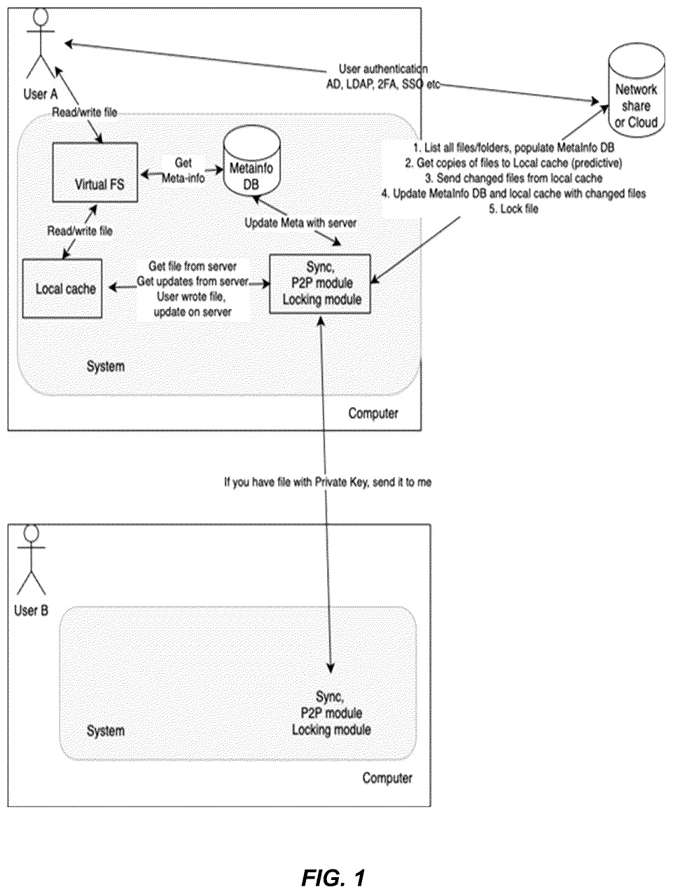

FIG. 1 illustrates a high-level architectural overview of a distributed file system or a client-side caching and synchronization mechanism for cloud storage. In some embodiments, this includes data consistency, peer-to-peer capabilities, and/or metadata management within a multi-user environment.

In some embodiments, the interaction is between a “Computer” (client-side system) and a “Network share or Cloud” (centralized server/storage). In some embodiments, a “P2P module” along with the “Sync, P2P module, Locking module” enables a peer-to-peer component. This enables direct file transfers or synchronization capabilities between client systems (e.g., between User A's and User B's computers). This can increase efficiency and/or redundancy, especially if “Private Key” transfer is involved.

The Virtual FS (Virtual File System) in FIG. 1 can act as an abstraction layer, providing a unified and consistent interface for user applications to interact with file data. The Virtual FS can also present a cohesive file namespace. The Local Cache of FIG. 1 can provide performance optimization and offline access. The Local Cache stores frequently accessed or recently modified files locally, reducing latency and network traffic. The “predictive” caching provides advanced algorithms for pre-fetching data based on user patterns or anticipated needs.

The Metainformation Database (DB) of FIG. 1 provides a dedicated database that stores metadata (e.g., file names, paths, sizes, timestamps, access permissions, versions, and potentially distributed ledger information for consistency). The “Get Meta-info” and “Update Meta with server” flows highlight the role of the Metainformation Database in maintaining a consistent view of the file system state across the client and the central server. The “Update Meta with server” indicates a push/pull mechanism can be used for keeping metadata synchronized.

The Sync, P2P module, Locking module of FIG. 1 provides distributed capabilities. For instance, the Synchronization (Sync) module can manage the reconciliation of file changes between the local cache, the centralized storage, and potentially other peer systems. The listed processes (sending changed files, updating metadata/cache) outline typical synchronization operations.

The P2P module can facilitate direct communication and data exchange between clients, bypassing or augmenting the central server. This could use distributed hash tables (DHTs) or other peer discovery mechanisms. The Locking module is optional and can be used for maintaining data integrity and preventing race conditions in a concurrent environment. The “Lock file” step includes a mechanism for acquiring and releasing locks on files (e.g., pessimistic or optimistic locking). This can ensure that only one user or process can modify a file at a time, or to manage concurrent read/write access.

The “User authentication (AD, LDAP, 2FA, SSO etc.)” step optionally shows that the system can use established authentication protocols. This enables secure access to the network share/cloud and proper authorization for file operations. In some embodiments shown, “If you have file with Private Key, send it to me” suggests a security mechanism involving symmetric cryptography with a shared key, or asymmetric cryptography, where private keys might be used for secure peer-to-peer communication, data encryption, or digital signing, providing data security and integrity in the distributed environment.

The numbered steps of FIG. 1 outline a typical client-side initialization and synchronization workflow:
1. Metadata Population: The client first fetches the directory structure and metadata from the central server.
2. Predictive Caching: Files likely to be accessed are proactively downloaded to the local cache, optimizing subsequent access times.
3. Delta Synchronization: Only modified file chunks or deltas are sent from the local cache to the server, improving network efficiency.
4. Metadata and Cache Update: The client's metadata and local cache are continually updated with the latest server-side changes, ensuring consistency.
5. Concurrency Control: The “Lock file” step signifies an explicit mechanism to manage concurrent access and prevent conflicts.

Some embodiments of the current disclosure, address the aforementioned challenges by introducing an innovative system and method designed to enhance network server performance through the utilization of local file and meta-information caching, along with two-way synchronization techniques. Operating on top of existing network share protocols (such as SMB, NFS, FTP, SharePoint, S3, or equivalents), the system achieves one or more of the following:
1. Utilizes existing authentications (login/passwords, AD/LDAP, 2FA, etc.).
2. Requires no alterations to networking infrastructure (no new ports, functions over existing VPN, etc.).
3. Imposes no modifications on servers or NAS.
4. Easily deployable and functions concurrently with existing file access methods.
5. Seamlessly integrates with all existing applications.

In some embodiments, at initialization, the system reads file/object metadata from the server once and generates local copies. This metadata includes file attributes like size, name, modification time, creation time, ACL, or other permissions. Users interact with this metadata through a virtual file system, enabling listing or access to all files without requiring server requests. Real-time two-way synchronization ensures any changes to the metadata are promptly reflected on the server.

File content (distinct from metadata) is synchronized from the server to a local cache only under one or more specific conditions:
1. When a user attempts to read/write to a particular file.
2. Based on predictive usage patterns of files.
3. Governed by specific file policies.

In some embodiments, following the initial cache population from the server, all subsequent file operations occur locally with the cached file copy, eliminating the need for server access. This approach accelerates file operations and provides offline file access.

In some embodiments, the system employs various techniques for expedited data synchronization with the server. The synchronization protocol includes error detection and correction techniques, peer-to-peer communication, independent block-level writes, and multithreaded access to the same file. Detailed explanations will be provided later in this document.

Real-time monitoring of files and metadata on the server ensures synchronization of only changes between the cache and network shares, significantly optimizing network load.

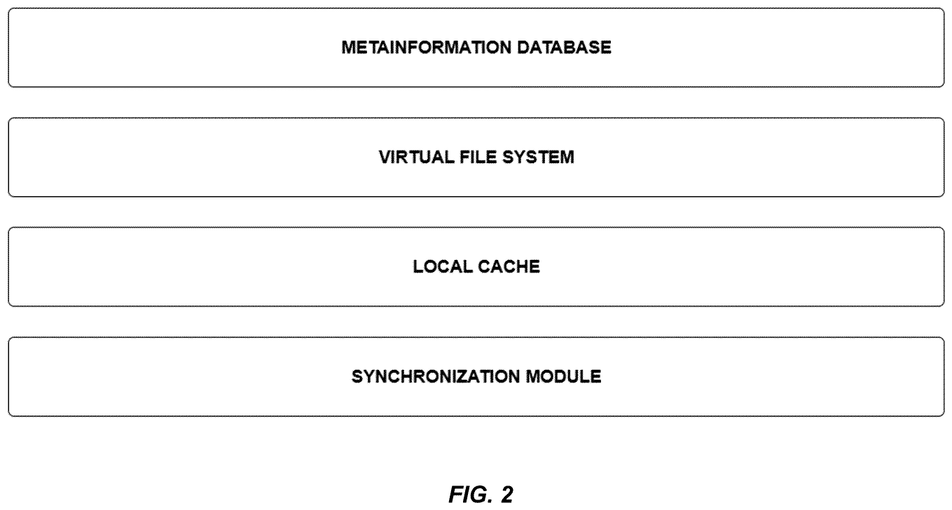

FIG. 2 illustrates a system for providing a filesystem on a local computer that includes a metainformation database, a virtual file system, a local cache, and a synchronization module that performs any of the steps discussed herein.

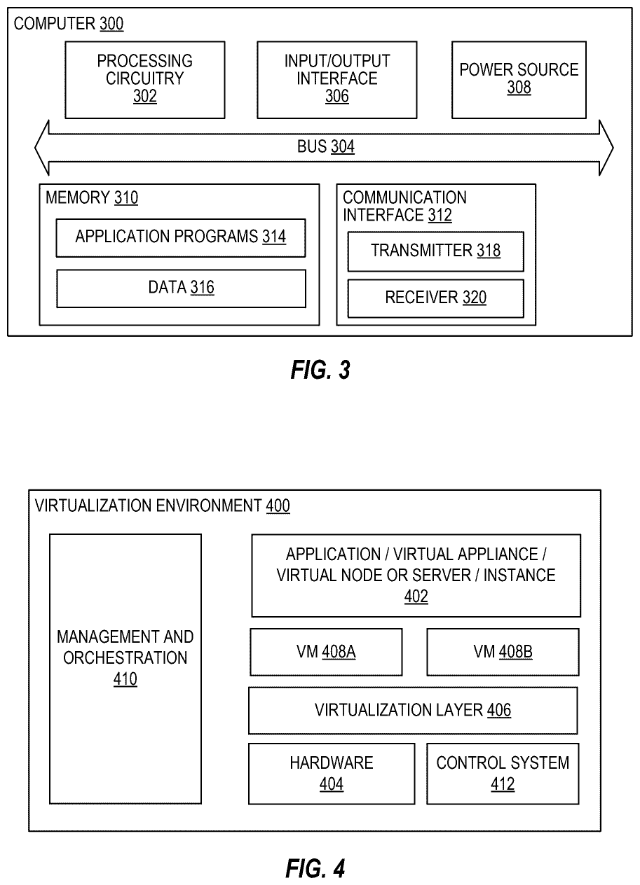

FIG. 3 shows a computer 300 in accordance with some embodiments. As used herein, a computer 300 refers to any device described herein. The computer 300 includes processing circuitry 302 that is operatively coupled via a bus 304 to an input/output interface 306, a power source 308, memory 310, a communication interface 312, and/or any other component, or any combination thereof. Certain computers may utilize all or a subset of the components shown in FIG. 3. The level of integration between the components may vary from one computer to another computer. Further, certain computers may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 302 may include multiple Central Processing Units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the computer 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging of the power source 308. Power circuitry may perform any formatting, converting, or other modification to the power from the power source 308 to make the power suitable for the respective components of the UE 300 to which power is supplied.

The memory 310 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 310 may allow the computer 300 to access instructions, application programs, and the like stored on transitory or non-transitory memory media, to off-load data, or to upload data. An article of manufacture, such as one utilizing a communication system, may be tangibly embodied as or in the memory 310, which may be or comprise a device-readable storage medium.

The processing circuitry 302 may be configured to communicate with a network using the communication interface 312. The communication interface 312 may comprise one or more communication subsystems. The communication interface 312 may include one or more transceivers used to communicate, such as by communicating with one or more remote transceivers of another device capable of wireless communication (e.g., another computer). Each transceiver may include a transmitter 318 and/or a receiver 320 appropriate to provide network communications (e.g., optical, electrical, frequency allocations, and so forth).

In the illustrated embodiment, communication functions of the communication interface 312 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

FIG. 4 is a block diagram illustrating a virtualization environment 400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtualization environments 400 hosted by one or more of hardware nodes, such as a hardware computing device that operates as a computer, or a host. Further, in embodiments in which the virtual node does not require radio connectivity, then the node may be entirely virtualized.

Applications 402 (which may alternatively be called software instances, virtual appliances, functions, virtual nodes, virtual functions, etc.) are run in the virtualization environment 400 to implement some of the features, functions, and/or benefits of some of the embodiments disclosed herein.

Hardware 404 includes processing circuitry, memory that stores software and/or instructions executable by hardware processing circuitry, and/or other hardware devices as described herein, such as a network interface, an input/output interface, and so forth. Software may be executed by the processing circuitry to instantiate one or more virtualization layers 406 (also referred to as hypervisors or Virtual Machine Monitors (VMMs)), provide VMs 408A and 408B (one or more of which may be generally referred to as VMs 408), and/or perform any of the functions, features, and/or benefits described in relation with some embodiments described herein. The virtualization layer 406 may present a virtual operating platform that appears like networking hardware to the VMs 408.

The VMs 408 comprise virtual processing, virtual memory, virtual networking, or interface and virtual storage, and may be run by a corresponding virtualization layer 406. Different embodiments of the instance of a virtual appliance 402 may be implemented on one or more of VMs 408, and the implementations may be made in different ways.

In some embodiments, a VM 408 may be a software implementation of a physical machine that runs programs as if they were executing on a physical, non-virtualized machine. Each of the VMs 408, and that part of the hardware 404 that executes that VM, be it hardware dedicated to that VM and/or hardware shared by that VM with others of the VMs, forms separate virtual elements.

The hardware 404 may be implemented in a standalone node with generic or specific components. The hardware 404 may implement some functions via virtualization. Alternatively, the hardware 404 may be part of a larger cluster of hardware (e.g., such as in a data center or CPE) where many hardware nodes work together and are managed via management and orchestration 410, which, among others, oversees lifecycle management of the applications 402.

Although the computing devices described herein may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the computer, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Those skilled in the art will recognize improvements and modifications to the embodiments of the present disclosure. All such improvements and modifications are considered within the scope of the concepts disclosed herein.

### EMBODIMENTS

Some embodiments are further described to provide additional examples of how the systems and methods can operate.

Embodiment 1. The system includes one or more of:
Metainformation database: Generated during the initial scan of network shares, storing diverse file and folder metadata. Metainformation Database updates are bidirectionally synchronized with the network share.
Virtual File System: Presents the Metainformation DB as a standard file system to users without necessitating network share access. It facilitates file data access from the local cache.
Local cache: Utilizes local, high-speed, and reliable storage to provide file content for reading and writing.
Synchronization module: Ensures bidirectional synchronization of metadata and file content between the network share and local computer, employing differential syncing for efficient updates. It utilizes various algorithms for error detection, recovery, and optimizing data transfer based on network share capabilities.
Predictive engine: Analyzes user file access patterns to proactively preload file content into the cache.
File policy engine: Governs cache management, defining cache size, handling older files, caching criteria, and retention policies.
File locking module: Extends OS file locking to the network share, preventing concurrent write access by other users when a file is opened locally.
Peer-to-peer data synchronization module: Facilitates metadata and file content exchange among users with access to the same folder without network share access.

Embodiment 2. The system described in embodiment 1 utilizes data caching techniques to optimize data read/write speeds. When a user saves a file, the application stores it in the local cache, enabling parallel write requests to the network share.

Embodiment 3. The system described in embodiment 1 employs machine learning algorithms within the predictive analysis module to predict user behavior and optimize data pre-caching strategies.

Embodiment 4. The method for optimizing network server performance includes one or more of:
Pre-populating file meta-information into a local DB to fulfill all meta-information requests from local storage.
Segregating file read/write operations from network share data transfer, ensuring users experience local disk IO performance, while file movement operations occur in the background without perceptible performance degradation.
Employing a robust synchronization engine to optimize write and read access to files, leveraging techniques such as block read/write, recovery of partially uploaded/downloaded files, and peer-to-peer optimization.
Predicting user demand and pre-caching frequently accessed data using a predictive analysis module.
Dynamically distributing incoming requests across server nodes using a load balancing module.
Implementing error recovery mechanisms without requiring file retransfer.
Optimizing access to local files and folders' metadata.
Employing various techniques for expedited storage access, including multi-threaded access and partial file access.

Embodiment 5. The system described in embodiment 1 can leverage peer-to-peer access to the files. When a user writes a file, the system generates a unique private key for a file and stores it in the file meta-data (like a stream). When other user wants to read the file, the system can get the file from the network share, or ask other systems for the file content by using the file private key.

In some embodiments, since a private key is randomly generated by a writer, the reader cannot guess it and have to obtain it from a file server from a file stream but first need to be properly authenticated by network share and have enough permissions to read the file.

In some embodiments, the peer-to-peer synchronization significantly reduces load to the network share and dramatically improve download speed for example for users in one office that are far from the network share.

Embodiment 6. The system implements out-of-band distributed file locking. The system could have one or more of two file-locking strategies:
Exclusive file locking. When local application tries to lock a file, the system tries to lock a file on network share. If system obtained a lock, then application is granted with a lock. If system cannot obtain the lock, then application is denied;
Advisory file locking. The system periodically check file lock information on network shares and updates local lock DB. Application is granted locks based on local DB and system updates network share later. This mode will be faster for users, but might introduce conflicts.

What is claimed is:

1. A system for providing a filesystem on a local computer, the system comprising:
a metainformation database;
a virtual file system capable of presenting the metainformation database as a standard file system;
a local cache to provide file content for reading and writing; and
a synchronization module providing bidirectional synchronization between metadata in the metainformation database and file content between one or more network shares and the local computer.

2. The system of claim 1 wherein the metainformation database is populated during an initial scan of one or more network shares.

3. The system of claim 1 wherein the metainformation database stores diverse file and folder metadata.

4. The system of claim 1 wherein updates to the metainformation database are bidirectionally synchronized with the network share.

5. The system of claim 1 wherein the virtual file system is capable of presenting the metainformation database as a standard file system without necessitating access to the one or more network shares.

6. The system of claim 1 wherein the virtual file system is capable of presenting the metainformation database as a standard file system through the local cache.

7. The system of claim 1 wherein the local cache uses local, high-speed, and reliable storage to provide file content for reading and writing.

8. The system of claim 1 wherein the synchronization module provides bidirectional synchronization using differential syncing.

9. The system of claim 1 wherein the synchronization module provides algorithms for one or more of: error detection, recovery, and optimizing data transfer based on capabilities of the one or more network shares.

10. The system of claim 1 further comprising: a predictive engine that analyzes file access patterns to proactively preload file content into the local cache from the one or more network shares.

11. The system of claim 1 further comprising: a file policy engine that governs management of the local cache.

12. The system of claim 11 wherein the file policy engine provides one of more of: defining cache size, handling older files, caching criteria, and retention policies.

13. The system of claim 1 further comprising: a file locking module.

14. The system of claim 13 wherein the file locking module extends file locking to the one or more network shares.

15. The system of claim 13 wherein the file locking module prevents concurrent write access when a file is opened locally.

16. The system of claim 1 further comprising: a peer-to-peer data synchronization module that facilitates one or more of: metadata and file content exchange among users with access to the same folder without network share access.

17. The system of claim 1 wherein when a user saves a file, the file is stored in the local cache, enabling parallel write requests to the one or more network shares.

18. The system of claim 1 wherein network server performance can be improved by one or more of:
pre-populating file meta-information into the metainformation database to fulfill all meta-information requests from local storage;
segregating file read/write operations from network share data transfer, ensuring users experience local disk IO performance, while file movement operations occur in the background without perceptible performance degradation;
employing a robust synchronization engine to optimize write and read access to files, leveraging techniques such as block read/write, recovery of partially uploaded/downloaded files, and peer-to-peer optimization;
predicting user demand and pre-caching frequently accessed data using a predictive analysis module;
dynamically distributing incoming requests across server nodes using a load balancing module;
implementing error recovery mechanisms without requiring file retransfer;
optimizing access to local files and folders' metadata; and
employing various techniques for expedited storage access, including multi-threaded access and partial file access.

19. The system of claim 1 wherein the User Experience (UX) is decoupled from the actual file storage.

20. A method for providing a filesystem on a local computer, the method comprising:
populating a metainformation database during an initial scan of one or more network shares;
presenting a virtual file system as a standard file system without necessitating access to the one or more network shares;
using a local cache to provide file content for reading and writing; and
providing bidirectional synchronization between metadata in the metainformation database and file content between one or more network shares and the local computer using a synchronization module.
